(19) United States
(12) Patent Application Publication
(10) Pub. No.: US 2020/0139166 A1
(43) Pub. Date: May 7, 2020

(54) FIRE SAFETY DEVICE

(71) Applicant: Southern Safety Products Limited Liability Company, Bloomsburg, PA (US)

(72) Inventors: Nicholas Welch, Bloomsburg, PA (US); Colby Geary, Birdsboro, PA (US); Mark Boudreau, Bangor, PA (US)

(73) Assignee: Southern Safety Products Limited Liability Company, Bloomsburg, PA (US)

(21) Appl. No.: 16/677,224

(22) Filed: Nov. 7, 2019

Related U.S. Application Data
(60) Provisional application No. 62/756,632, filed on Nov. 7, 2018.

(51) Int. Cl. A62B 11/00; B01D 46/00; B01D 53/04; B01D 53/86; B01D 46/42; B01D 46/44; A62B 13/00; A62B 15/00

(52) U.S. Cl. CPC A62B 11/00; B01D 46/0093; B01D 53/04; B01D 53/86; B01D 46/0036; B01D 46/4245; B01D 2253/102; B01D 46/442; A62B 13/00; A62B 15/00; B01D 2255/20761; B01D 2255/2073; B01D 46/448

(57) ABSTRACT

Many people die each year from smoke inhalation due to residential fires. An enclosed space that provides clean and breathable air to people can save many lives when there is a fire and people are unable to escape. The device can be placed in a small and easily accessible space in a dwelling. The device recirculates and purifies air so that people can breathe while they wait for emergency responders.

### CROSS-REFERENCE

This application claims the benefit of U.S. Provisional Application No. 62/756,632, filed Nov. 7, 2018, which application is incorporated herein by reference.

### BACKGROUND OF THE INVENTION

Annual fire related deaths total around 2,500 nationwide. Smoke inhalation is the primary cause of death for victims in fires.

An air filtration system that recirculates and purifies air in an enclosed space that is easily accessible to an individual in the event of an emergency will reduce the amount of deaths related to fires each year. The system provides additional breathable air for a limited period of time in the event of a residential fire where a person is unable to escape the building and is, e.g., awaiting assistance from emergency rescue personnel.

### SUMMARY OF THE INVENTION

In some embodiments, the invention is a fire safety device comprising: an air recirculation and purification system; an air flow tunnel; a carbon scrubber; a door sweep; a sensor unit; and a power source. In some aspects, the fire safety device has a power source that is selected from the group consisting of: a 12-volt battery, a lithium battery, a AAA battery, a AA battery, a C battery, a D battery, a car battery, a nickel cadmium battery, a nickel metal hydride battery, a lithium ion battery, a small sealed lead acid battery. In some aspects, the fire safety device has a power source that is rechargeable. In some aspects, at least about 80% of carbon products are removed from the air by the fire safety device. In some aspects, at least about 80% of airborne contaminants are removed from the air by the fire safety device. In some aspects, the fire safety device has a sensor unit that senses smoke. In some aspects, the fire safety device has a sensor unit that senses heat. In some aspects, the fire safety device has a sensor that senses air borne contaminants. In some aspects, the fire safety device has a sensor unit that automatically initiates the system. In some aspects, the fire safety device has a sensor unit that alerts others using a strobe light. In some aspects of the fire safety device, the air recirculates within the unit. In some aspects of the fire safety device, the air is recirculated at least 1 time per minute. In some aspects, the fire safety device has a door sweep that prevents smoke from entering the unit. In some aspects, the fire safety device has a carbon scrubber comprising a filter. In some aspects, the filter is comprised of a hopcalite catalyst and coconut shell activated charcoal.

In some embodiments, the invention is a fire safety device comprising: an air recirculation and purification system wherein breathable air can be circulated for at least 10 minutes during an active fire and wherein said fire safety device is installed in an enclosed space is sized such that it will accommodate at least 1 human being during a fire; and an alarm to notify emergency personnel. In some aspects, during an active fire, smoke contaminants in an enclosed space are reduced to a level that can allow a human to breath at a level to maintain life for 30 minutes. In some aspects, the air is substantially recirculated in the fire safety device. In some aspects of the fire safety device, the enclosed space is sized to accommodate at least 2 human beings.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an exemplary illustration of a fire safety device.

FIG. 2 is an exemplary illustration of a fire safety device.

FIG. 3 is an exemplary illustration of a component of a fire safety device.

FIG. 4 is an exemplary illustration of a component of a fire safety device.

FIG. 5 is an exemplary illustration of a component of a fire safety device.

FIG. 6 is an exemplary illustration of a component of a fire safety device.

FIG. 7 is an exemplary illustration of a component of a fire safety device.

FIG. 8 is an exemplary illustration of a main housing compartment of a component of a fire safety device.

FIG. 9 is an exemplary illustration of a main housing compartment of a component of a fire safety device.

FIG. 10 is an exemplary illustration of a main housing compartment of a component of a fire safety device.

FIG. 11 is an exemplary illustration of a fan.

FIG. 12 is an exemplary illustration of a fan.

FIG. 13 is an exemplary illustration of a door.

FIG. 14 is an exemplary illustration of a door.

FIG. 15 is an exemplary illustration of a door.

FIG. 16 is an exemplary illustration of a filter.

FIG. 17 is an exemplary illustration of a fire safety device.

FIG. 18 is an exemplary illustration of an interior view of a fire safety device.

FIG. 19 is an exemplary illustration of a component of an interior view of a front panel of a fire safety device.

FIG. 20 is an exemplary illustration of a smoke detector housing of a fire safety device.

FIG. 21 is an exemplary illustration of an inside view of a smoke detector housing of a fire safety device.

FIG. 22 is an exemplary illustration of a filter of a smoke detector housing.

FIG. 23 is an exemplary illustration of a fire safety device.

FIG. 24 is an exemplary illustration of a fire safety device.

### DETAILED DESCRIPTION OF THE INVENTION

In some embodiments, the device can transform enclosed spaces, e.g. closets, into a temporary emergency space. In some embodiments, the device can transform the enclosed space for a limited time. In some embodiments, the device can increase breathable air. In some embodiments, the device can decrease carbon. In some embodiments, the device can increase oxygen.

In some embodiments, the device can comprise an integrated circuit. In some embodiments, the device comprises an external battery status panel. In some embodiments the device comprises a battery compartment located behind the removeable front panel. In some embodiments, the device can be powered by a 12-volt battery. In some embodiments, the device can be powered by one or more batteries selected from the group consisting of: AA battery, AAA battery, C battery, D battery, 9 Volt battery, lithium battery (e.g. lithium ion battery), a car battery, a rechargeable battery, a NiCd battery, NiMH battery, a sealed lead acid battery, a valve-regulated lead acid battery, Absorbed glass mat (i.e. AGM) battery, gel battery (i.e. gel cell), and any combination thereof. Once skilled in the art will recognize that the battery can be selected from: any household battery, industrial or vehicle battery, so long as it is able to sufficiently power the device for a period of time.

In some embodiments, the battery can be easily removed. In some embodiments, the battery can be rechargeable. In some embodiments, the device can comprise a low voltage alarm that can indicate that the unit needs to be recharged.

In some embodiments, the device can include a sensor unit in an adjacent space that can sense various aspects of the environment. In some embodiments, a sensor can sense smoke, heat, CO, CO₂, Carbon-based air contaminants, smoke particles, particulates, air borne microbes, cyanide, gases, and any combination thereof. One skilled in the art will recognize sensors can detect many air components that may be useful for use in a fire emergency. Once the sensor unit senses smoke, heat, CO, etc., the sensor unit can automatically initiate the system.

In some embodiments, the device can include a manual activation switch to start the system. In some embodiments, the device can include a manual deactivation switch to stop the system. In some embodiments, the device can also include a manual test function to test the system. In some embodiments, the manual activation switch, the manual deactivation switch, and the manual test switch can be a push button.

In some embodiments, the device can emit a light when in commission to illuminate the enclosed space. In some embodiments, the device can emit light-emitting diode (LED) light, fluorescent light, incandescent light, halogen light, and any combination thereof.

In some embodiments, the device can alert emergency personnel and others that people are in the device. In some embodiments, the device can include a strobe light that can alert emergency personnel and others. In some embodiments, the device can include light vibration to alert others. In some embodiments, the device can include sound to alert others. In some embodiments, the device can include Bluetooth to alert others. In some embodiments, the device can include a digital notification to alert others. In some embodiments, the device can have wi-fi connection to alert others. In some embodiments, the device can have emergency cellular capabilities to alert others. In some embodiments, individuals can communicate using the emergency cellular capabilities using the speaker. In some embodiments, individuals can communicate using the emergency cellular capabilities using the microphone.

In some embodiments, the device can purify air. In some embodiments, the device can comprise an air filter. In some embodiments, the device can comprise a carbon scrubber. In some embodiments, the device can comprise a carbon byproduct scrubbing system designed for expired CO₂ from hyperventilation, CO, cyanide, other particulates produced by fires, and any combination thereof. In some embodiments, the device can initiate intake and exhaust fans with an in-line carbon filter. In some embodiments, the device can remove at least about: 80%, 82%, 84%, 86%, 88%, 90%, 92%, 94%, 96%, 98%, 99%, or more of carbon products and airborne contaminants.

In some embodiments, the device can purify air. In some embodiments, the device can comprise an air filter. In some embodiments, the filter can be designed to oxidize the carbon monoxide and capture the carbon dioxide. In some embodiments, the filter medium can consist of a mixture of a hopcalite oxidation catalyst and a charcoal. In some embodiments, the hopcalite catalyst can be doped with tin. In some embodiments, the charcoal can be activated charcoal, e.g., coconut shell activated charcoal.

In some embodiments, the hopcalite catalyst can convert carbon monoxide into carbon dioxide. In some embodiments, the carbon dioxide can be absorbed by the charcoal. In some embodiments, the device can initiate intake and exhaust fans with the carbon filter. In some embodiments, the device can remove at least about: 80%, 82%, 84%, 86%, 88%, 90%, 92%, 94%, 96%, 98%, 99%, or more of carbon products and airborne contaminants.

In some embodiments, the device can recirculate air in the unit. In some embodiments, the device can include an air flow tunnel. In some embodiments, the device can comprise of fans. In some embodiments, the device can draw from air that is already contained in the unit to recirculate the air. In some embodiments, the device can recirculate air at least: 1, 2, 3, 4, 5, 6, 7, 8, 9, or 10 times per minute or more.

In some embodiments, the device can provide a person with at least 1 minute, 5 minutes, 10 minutes, 15 minutes, 30 minutes, 1 hour, 2 hours, and 3 hours of life-sustaining, breathable air. In some embodiments, the device can prevent smoke from entering the unit. In some embodiments, the device can include a door sweep to prevent smoke from entering into the unit.

### Example 1

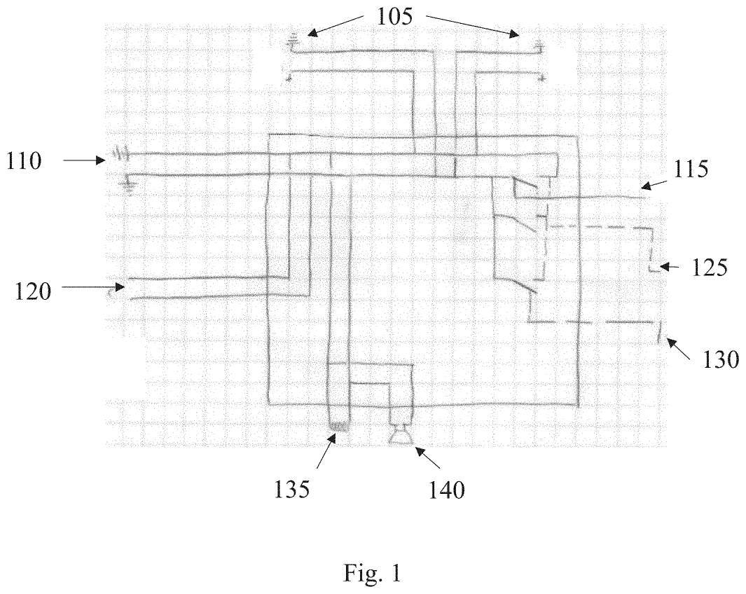

FIG. 1 depicts an illustration of an exemplary embodiment of the device comprising: one or more fans (105), one or more batteries (110), one or more sensors (115), a charger, (120) a test switch (125), a manual on/off switch (130), one or more battery statuses (135) and an alarm (140).

### Example 2

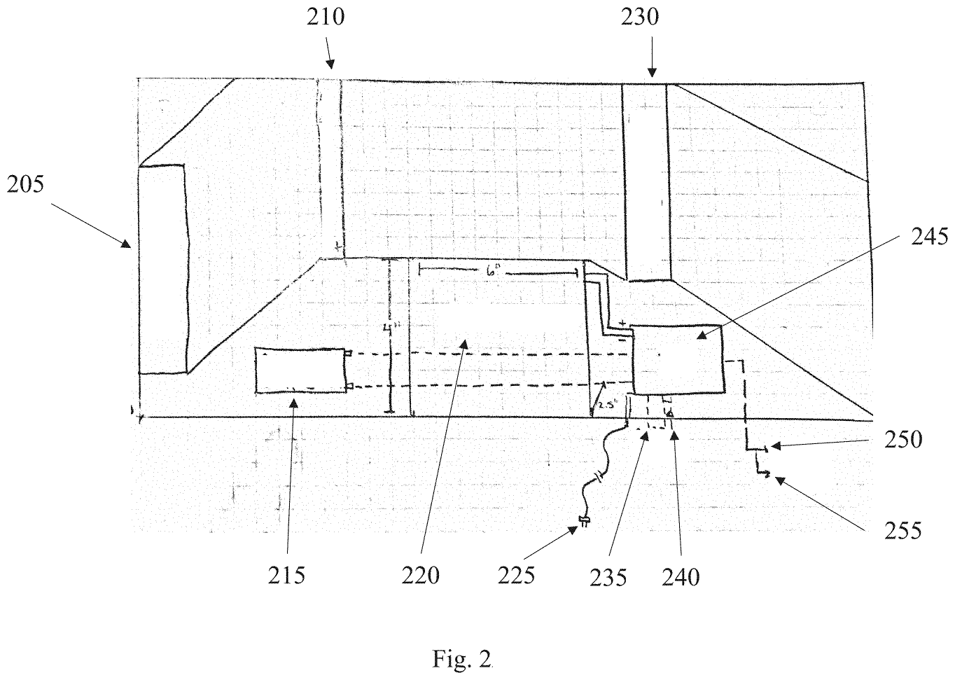

FIG. 2 depicts an illustration of an exemplary embodiment of the device comprising: one or more intake fans (205), one or more carbon filters (210), one or more battery chargers (215), one or more batteries (220), one or more charging cables (225), one or more exhaust fans (230), one or more battery statuses (235), one or more alarms (240), IC (245), one or more sensors (250), and a test switch (255).

### Example 3

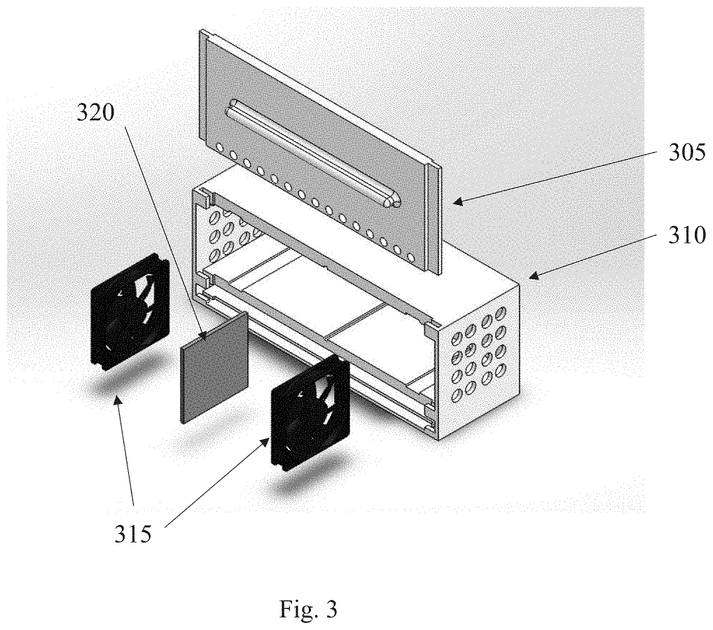

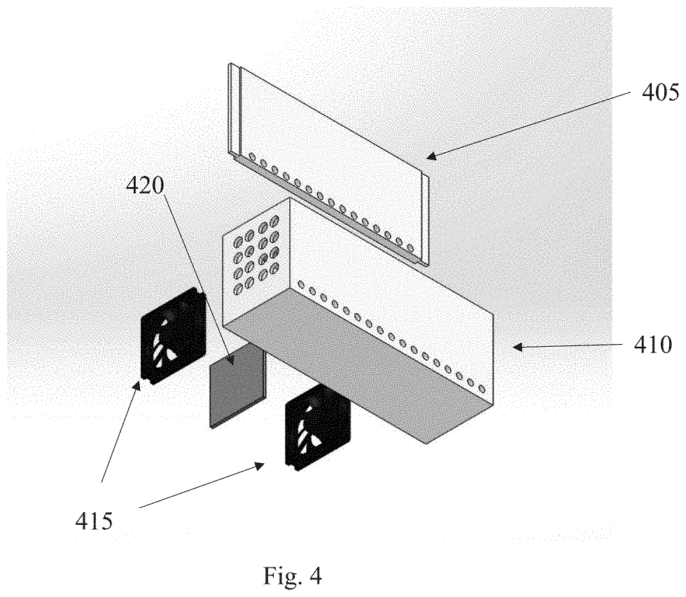

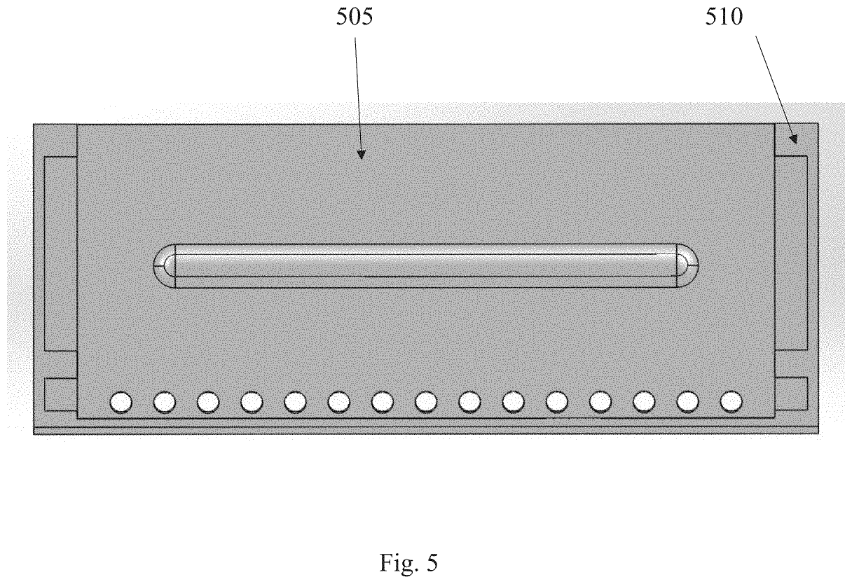

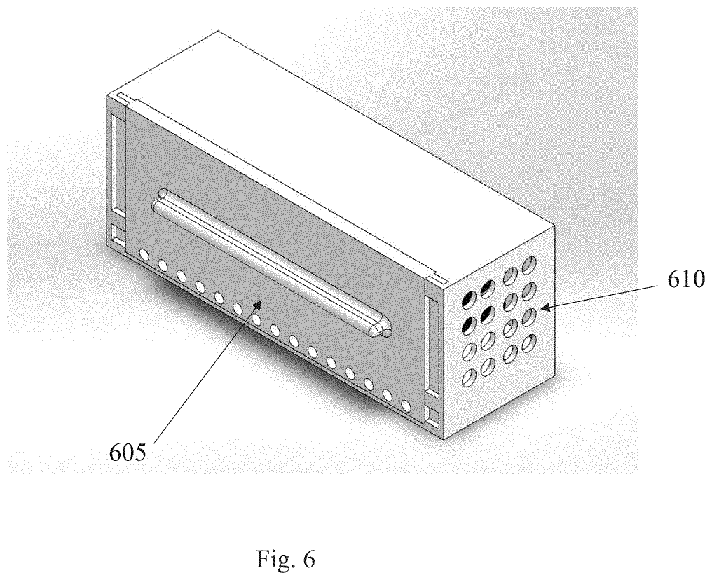

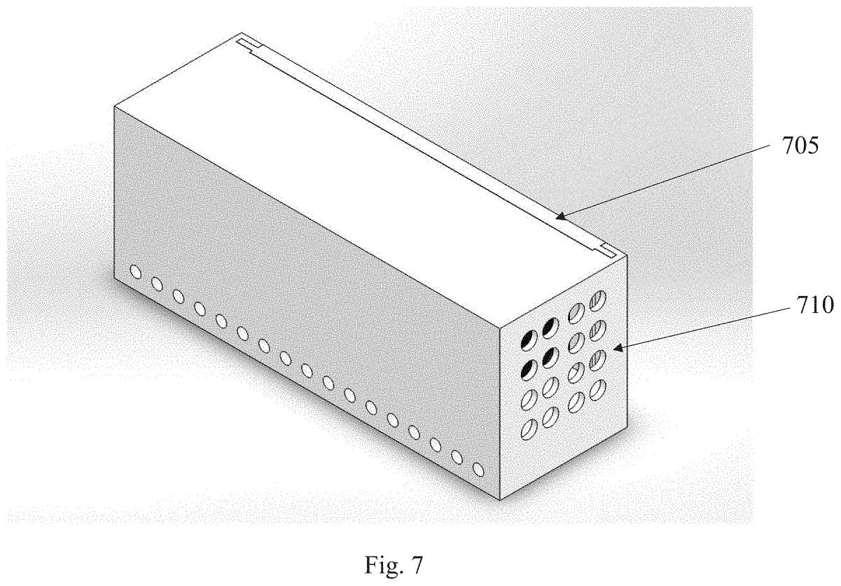

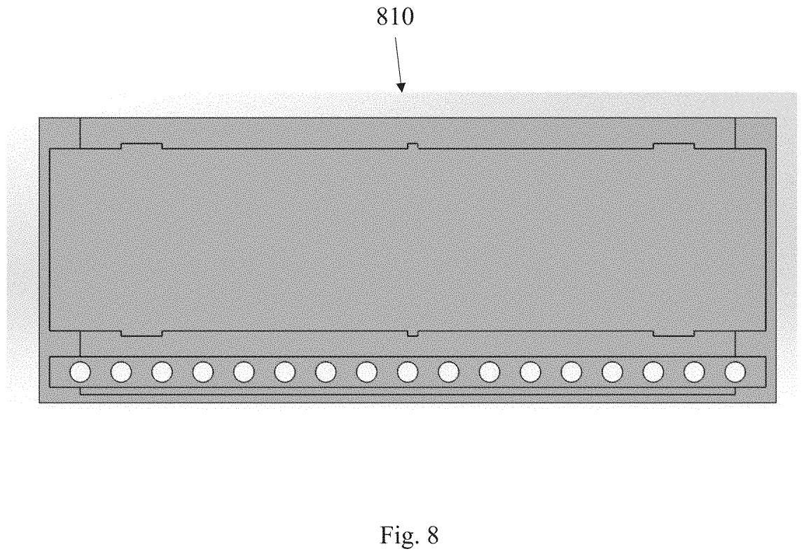

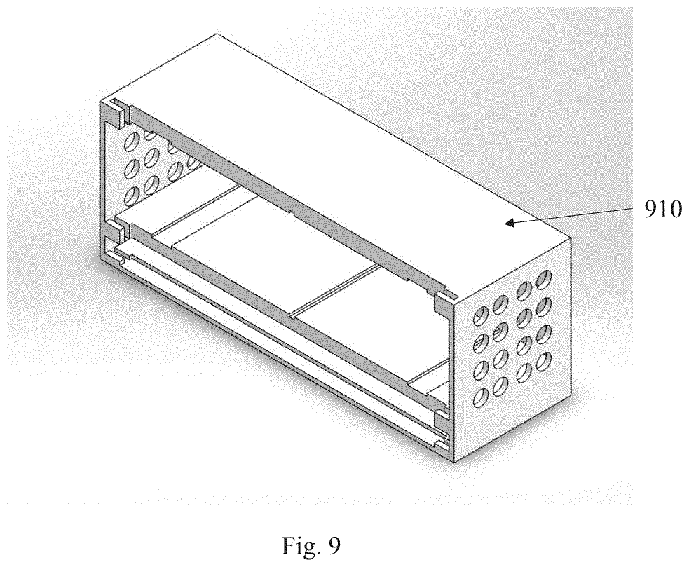

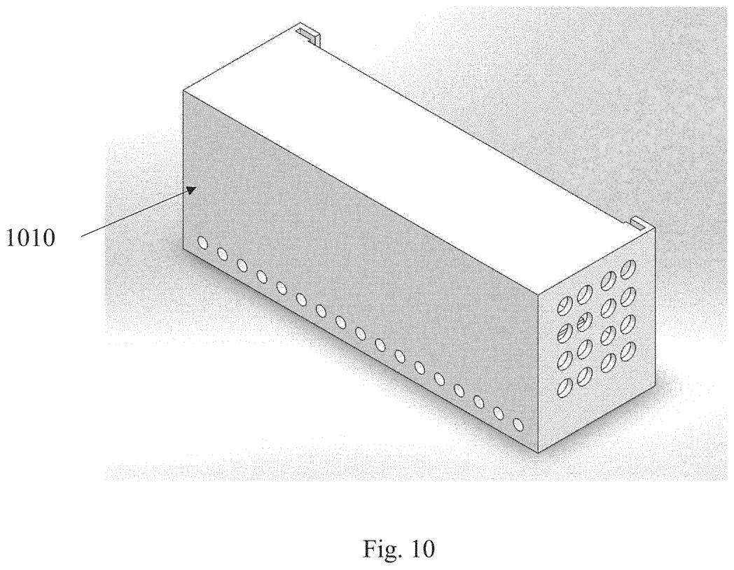

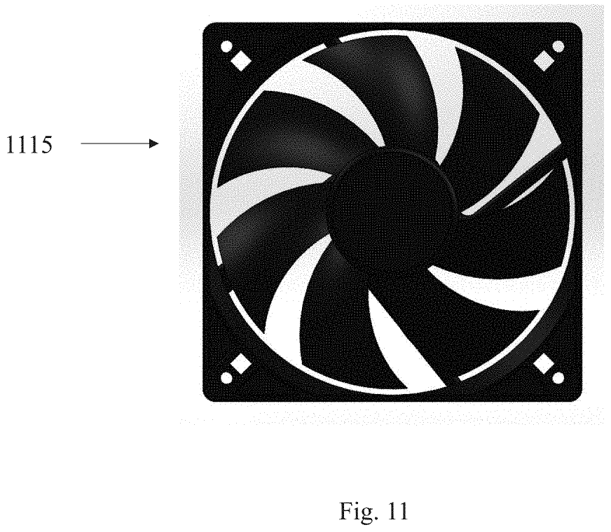

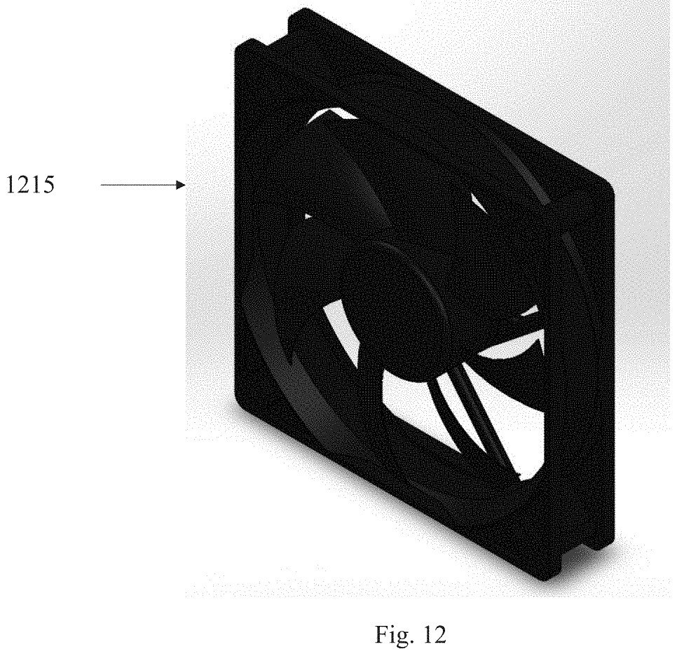

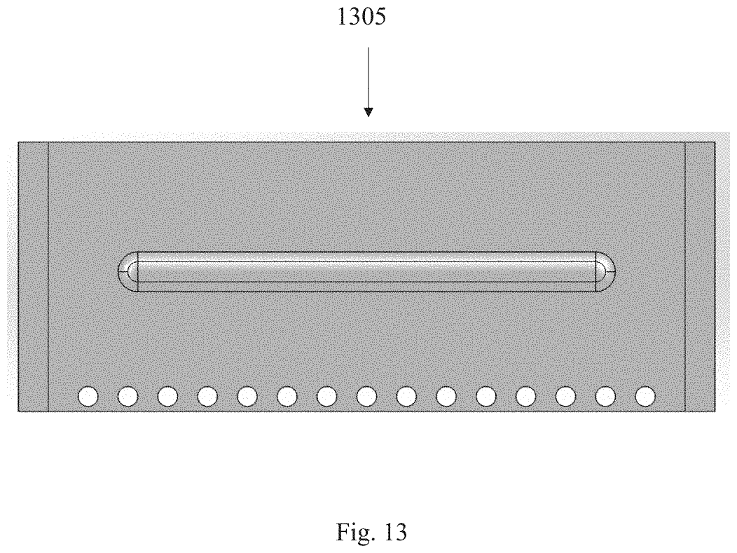

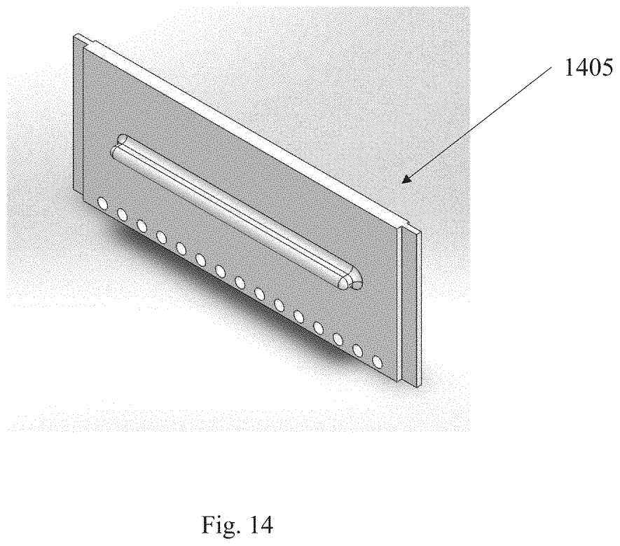

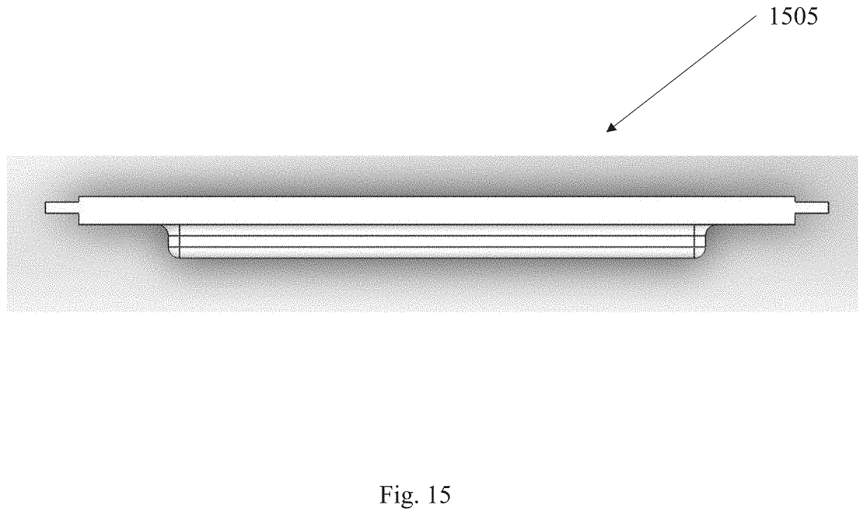

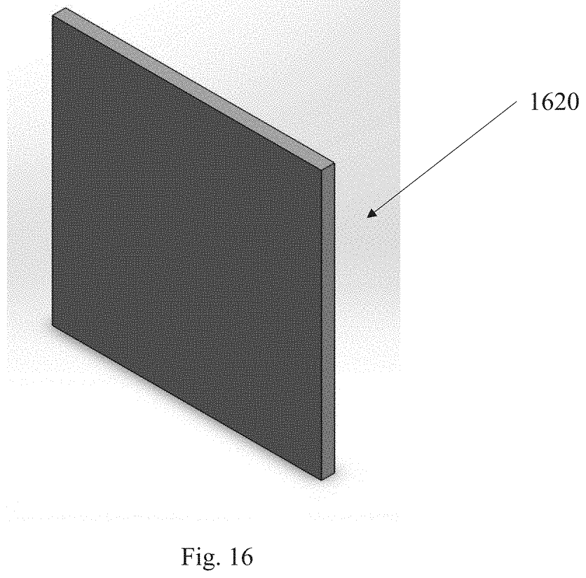

FIGS. 3, 4, 5, 6, 7, 8, 9, 10, 11, 12, 13, 14, 15, and 16 are illustrations of a component of a fire safety device. This embodiment comprises a door (305) (405) (505) (605) (705) (1305) (1405) (1505), a main housing compartment (310) (410) (510) (610) (710) (810) (910) (1010), one or more fans (315) (415) (1115) (1215), and one or more filters (320) (420) (1620). FIG. 3 is an off-centered front view of this embodiment, while FIG. 4 is an off centered back view. FIG. 5 is a front view is the embodiment assembled, while FIG. 6 is an off centered front view assembled, and FIG. 7 is an off centered back view assembled. FIG. 8 is a front view of the main housing compartment while FIG. 9 is an off centered front view of the main housing compartment and FIG. 10 is an off centered back view of the main housing compartment. FIG. 11 is a front view of a fan and FIG. 12 is an off centered front view of a fan. FIG. 13 is a front view of the door while FIG. 14 is an off centered front view of the door and FIG. 15 is a top view of the door. FIG. 16 is an off centered front view of a HEPA filter.

### Example 4

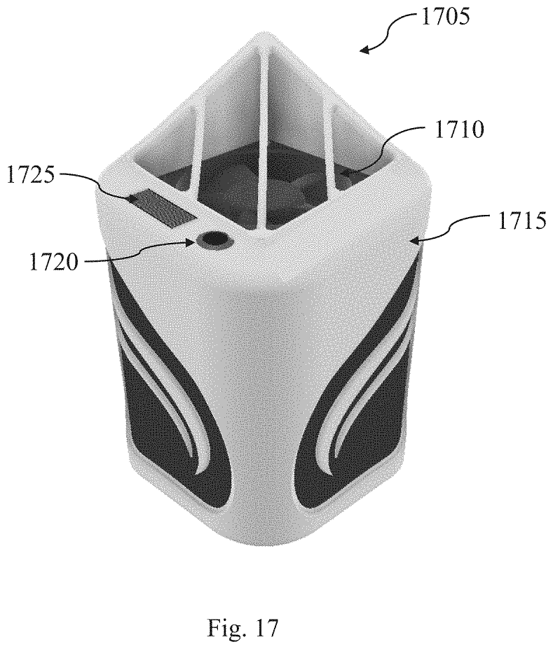

FIG. 17 depicts an illustration of an exemplary embodiment of the fire safety device (1705) comprising: one or more fan coupler (1710), a removable front panel (1715), a manual on/off push button (1720), and a speaker/microphone (1725).

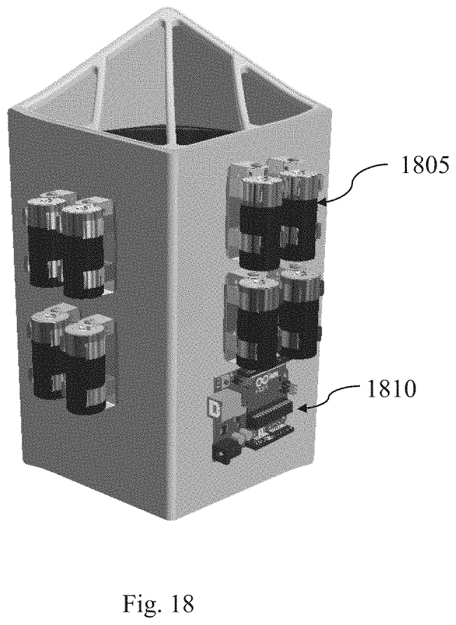

FIG. 18 depicts an illustration of an exemplary embodiment of the inside of a fire safety device comprising: a battery compartment (1805) and an integrated circuit (1810).

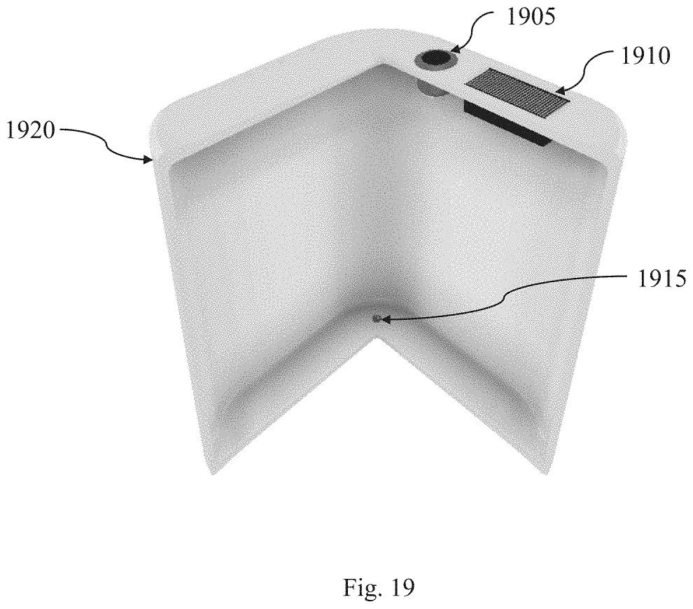

FIG. 19 depicts an exemplary illustration of an interior view of a removeable front panel (1905) of a fire safety device. This embodiment comprises a manual on/off push button (1910), a speaker/microphone (1915), and a LED hole (1920).

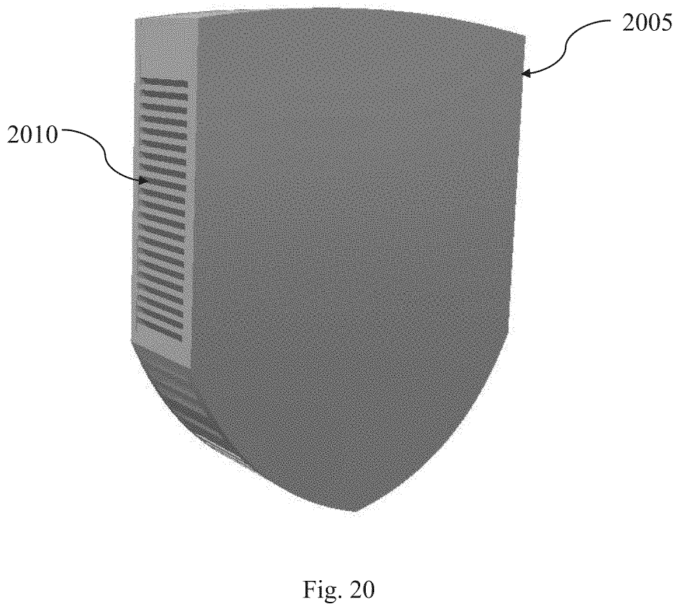

FIG. 20 depicts an off-centered front view of the smoke detector housing (2005) comprising one or more grated side panels (2010). The grated side panels (2010) can be positioned so that when the smoke enters the smoke detector housing (2005) through the grated side panels (2010), light is scattered by the smoke and then detected by the receiver.

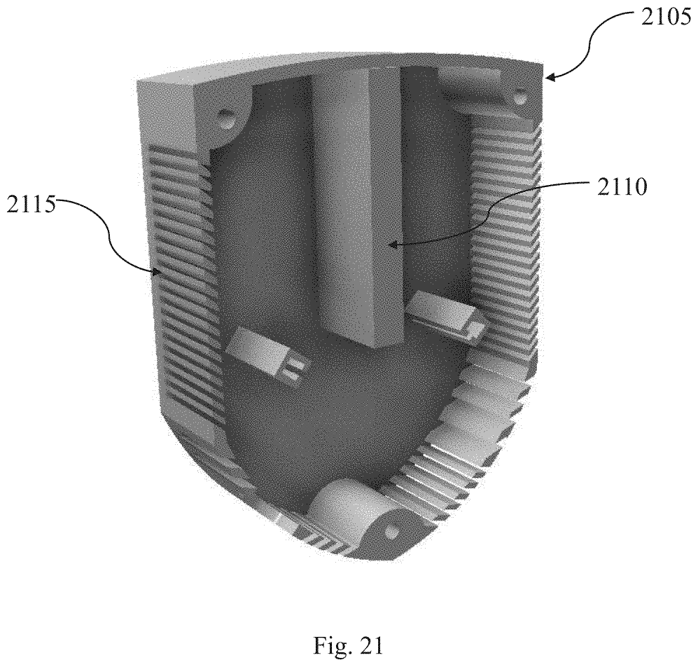

FIG. 21 depicts an off-centered interior view of the smoke detector housing (2105). This embodiment can comprise a receiver (2110) and one or more grated side panels (2115). When smoke enters the one or more grated side panels (2115), light is scattered by the smoke and can be detected by the receiver (2110). The receiver (2110) then translates the intensity of light into a voltage which is inputted into the microcontroller within the fire safety device.

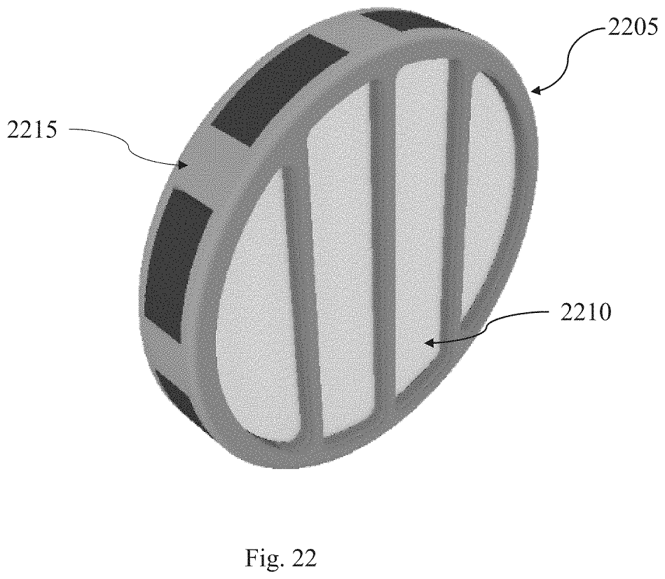

FIG. 22 depicts an exemplary illustration of a front view of a filter. The non-limiting embodiment of the multistage filtering process comprises one or more end caps (2205), one or more mesh screens (2210), and a housing ring (2215). The one or more mesh screens (2210) separate the layers of the filter for a multistage filtering process. The one or more end caps (2205) can contain one or more mesh screens (2210).

### Example 5

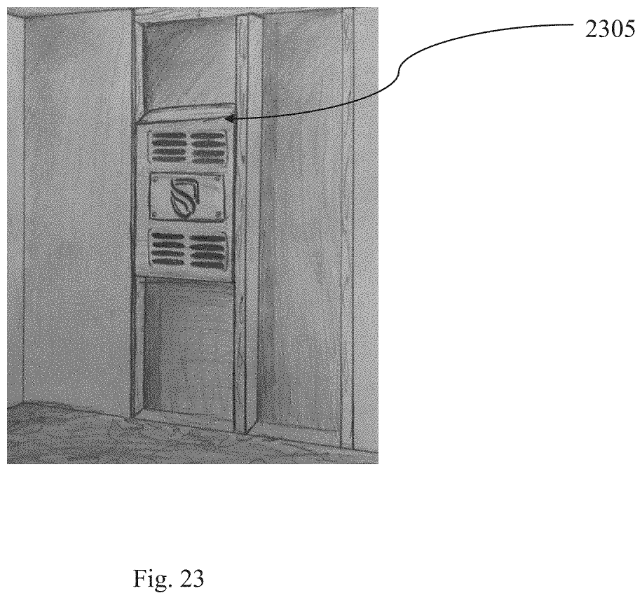

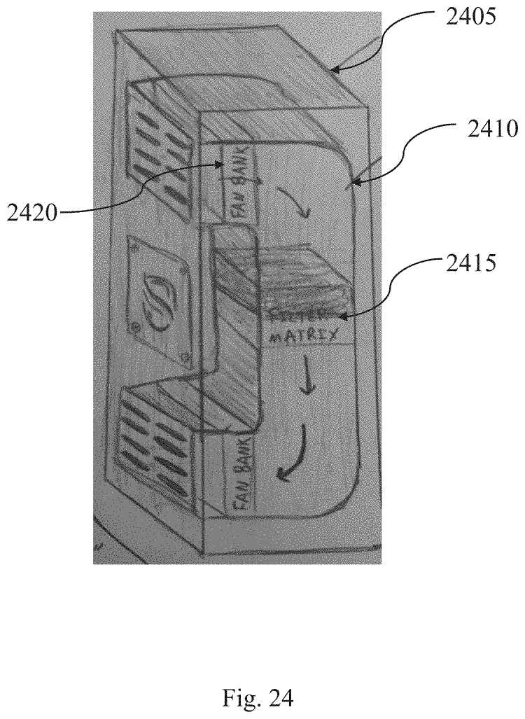

FIG. 23 depicts an exemplary illustration of a fire safety device. FIG. 24 depicts an exemplary illustration of a fire safety device comprising an outer panel (2405), a flow chamber (2410), one or more fan banks (2415), and a filter matrix (2420).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A fire safety device comprising:
an air recirculation and purification system;
an air flow tunnel;
a carbon scrubber;
a door sweep;
a sensor unit; and
a power source.

2. The fire safety device of claim 1, wherein said power source is selected from the group consisting of: a 12-volt battery, a lithium battery, a AAA battery, a AA battery, a C battery, a D battery, a car battery, a nickel cadmium battery, a nickel metal hydride battery, a lithium ion battery, a small sealed lead acid battery.

3. The fire safety device of claim 1, wherein said power source is rechargeable.

4. The fire safety device of claim 1, wherein at least about 80% of carbon products are removed from the air.

5. The fire safety device of claim 1, wherein at least about 80% of airborne contaminants are removed from the air.

6. The fire safety device of claim 1, wherein said sensor unit senses smoke.

7. The fire safety device of claim 1, wherein said sensor unit senses heat.

8. The fire safety device of claim 1, wherein said sensor senses air borne contaminants.

9. The fire safety device of claim 1, wherein said sensor unit automatically initiates the system.

10. The fire safety device of claim 1, wherein the sensor unit alerts others using a strobe light.

11. The fire safety device of claim 1, wherein the air recirculates within the unit.

12. The fire safety device of claim 1, wherein the air is recirculated at least 1 time per minute.

13. The fire safety device of claim 1, wherein said door sweep prevents smoke from entering the unit.

14. The fire safety device of claim 1, wherein said carbon scrubber comprises a filter.

15. The filter of claim 14, wherein said filter comprises a hopcalite catalyst and coconut shell activated charcoal.

16. A fire safety device:
(i) an air recirculation and purification system wherein breathable air can be circulated for at least 10 minutes during an active fire and wherein said fire safety device is installed in an enclosed space is sized such that it will accommodate at least 1 human being during a fire;
(ii) an alarm to notify emergency personnel
(iii) one or more cellular capabilities to notify emergency personnel
(iv) a light to illuminate the enclosed space.

17. A fire safety device of claim 16, wherein during an active fire, smoke contaminants in said enclosed space are reduced to a level that can allow a human to breath at a level to maintain life for 30 minutes.

18. The fire safety device of claim 16, wherein the air is substantially recirculated.

19. The fire safety device of claim 16, wherein the enclosed space is sized to accommodate at least 2 human beings.
